(19) United States
(12) Patent Application Publication
(10) Pub. No.: US 2009/0052536 A1
(43) Pub. Date: Feb. 26, 2009

(54) Video Decoding Device, Decoded Image Recording Device, Their Method and Program

(75) Inventor: Junji Tajime, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 12/223,782

(22) PCT Filed: Feb. 7, 2007
(86) PCT No.: PCT/JP2007/052096

§ 371 Date: Aug. 8, 2008

(30) Foreign Application Priority Data
Feb. 9, 2006 (JP) 2006-032510

(51) Int. Cl. H04N 7/26; H04N 11/02

(52) U.S. Cl. 375/240.13; 375/240.12; 375/240.25; 375/E07.03

(57) ABSTRACT

[Problems] To provide a video decoding device and a decoded image recording device, having a recompression unit capable of suppressing propagation of distortion caused by temporal and spatial recompression, that is, image deterioration, and their methods and programs.

[Means for Solving the Problems] The video decoding device includes a reference degree weighting recompression block 102 in which reference feasibility of a certain image position within a frame from a reference image position to be referred to in a compression encoding system, which is an object of a decoding device, is set. The reference degree weighting recompression block 102 performs recompression with a control to increase the number of allocated bits of a quantization representative value for an image which is easily referred to.

### TECHNICAL FIELD

The present invention relates to a video decoding device to which a coded video bitstream is input. In particular, the present invention relates to a video decoding device and a decoded image recording device, having a measure for recompressing a decoded image in order to reduce the memory capacity and the memory bandwidth required for decoding, and their methods and programs.

### BACKGROUND ART

With the rapid development of digital technology in recent years, digital video coding systems such as MPEG-2 VIDEO (ISO 13818-2/ITU-TH.262), MPEG-4 Visual (ISO 14496-2), H.264 (ITU-T H.264/ISO 14496-10) have been widely used.

However, there is a problem that a video decoding device to which a coded video bitstream is input requires a large amount of memory capacity and memory bandwidth due to complicated coding systems and higher resolution of images to be coded.

As a method for solving this problem, a video decoding device having a measure for recompressing a decoded image has been disclosed. As a typical technique of such a video decoding device having a measure for recompressing a decoded image, a conventional video decoding device described in Patent Document 1 is shown in FIG. 2.

This video decoding device includes a decoding block 201, a recompression block 202, a prediction frame memory block 203, a first extension block 204, and an address control block 205. In the following description, description of the displaying function, which is described in Patent Document 1, is omitted.

Specifically, a second extension block is deleted, and a prediction and display frame memory block is changed to the prediction frame memory block 203.

The decoding block 201 decodes an image using an input coded video bitstream and a reference image which is extended by the extension block 204. To the decoded image which is decoded by the decoding block 201, recompression processing is performed by the recompression block 202, including quantization in which different numbers of bits are allocated to respective pixels or respective recompression processing units, so that the amount of decoded information is reduced.

The recompressed data which is recompressed by the recompression block 202 is written into the prediction frame memory block 203 for use as a reference image for an image to be decoded later. In writing, the address control block 205 generates an address of the frame memory such that the recompressed data is written at an address position corresponding to each recompression processing unit, and supplies the data to the prediction frame memory block 203 via an address line.

The written recompressed data is extended by the extension block 204 for decoding.

The same invention is also disclosed in Patent Documents 2 to 11.

Next, effects of the video decoding device disclosed in Patent Document 1 will be described using a specific example. In the following description, H.264 will be considered as the decoding block 201 of the video decoding device disclosed in Patent Document 1.

FIG. 3 is a block diagram showing an H.264 decoding device having a measure for recompressing a decoded image.

H.264 is based on hybrid encoding in which motion compensation and frequency transform are combined, as MPEG-2 VIDEO and MPEG-4 Visual, and also uses intra (spatial, in-frame) prediction and a deblocking filter which are new techniques. In FIG. 3, a reference numeral 301 indicates a variable length decoding block, 302 indicates a scaling/inverse quantization/inverse integer transformation block, 30 indicates an adder, 304 indicates a deblocking filter block, 32 indicates a compression block, and 33 indicates a prediction frame memory block. Further, a reference numeral 305 indicates an intra prediction block, 306 indicates a motion compensation block, 34 indicates an extension block, and 35 indicates an address control block.

As a coding system of the recompression block 202, one-dimensional difference PCM (1-D DPCM) shown in FIG. 4 will be considered.

In FIG. 4, a recompression processing unit of a luminance signal is set to be 8 pixels which is a half of the macroblock (MB) width which is one of coding processing units of H.264, and non-linear quantization is performed using a left pixel as a reference pixel in which a prediction error value has a quantization representing value of 5-bit fixed.

FIG. 5 shows a frame average luminance signal PSNR (Peak Signal to Noise Ratio) of a decoded image of a typical H.264 decoding device (having no recompressing unit) in a certain video sequence and a decoded image of an H.264 decoding device having a recompression unit.

In this case, coding conditions of H.264 are set such that intra prediction frame interval N includes 15 frames and reference frame interval M includes 3 frames.

As a decoded image is recompressed in the video decoding device having a recompression unit, distortion caused by recompression is included in the reference image unless an irreversible transformation system is used as a coding system for recompression.

This distortion is accumulated until an intra prediction frame is decoded.

This is confirmed in FIG. 5 that a deterioration cycle of PSNR is N frames. In this example, however, PSNR is as high as 42 dB or more (distortion is small) even in the immediately preceding frame of the intra prediction frame where deterioration of PSNR becomes the highest, and no substantial deterioration of picture quality was recognized.

From this example, it can be said that a video decoding device having a recompression unit is effective in a case of inputting a video bitstream where N is short.

Patent Document 1: Japanese Patent Laid-Open Publication No. 9-247671 (pp. 7-8, FIG. 1)

Patent Document 2: Japanese Patent Laid-Open Publication No. 9-247671 (FIG. 1)

Patent Document 3: Japanese Patent Laid-Open Publication No. 9-261635 (FIG. 1)

Patent Document 4: Japanese Patent Laid-Open Publication No. 10-4550 (FIG. 1)

Patent Document 5: Japanese Patent Laid-Open Publication No. 10-271516 (FIG. 1)

Patent Document 6: Japanese Patent Laid-Open Publication No. 10-66081 (FIG. 1)

Patent Document 7: Japanese Patent Laid-Open Publication No. 11-298892 (FIG. 1)

Patent Document 8: Japanese Patent Laid-Open Publication No. 11-341288 (FIG. 1)

Patent Document 9: Japanese Patent Laid-Open Publication No. 2004-254344 (FIG. 1)

Patent Document 10: Japanese Patent Publication No. 3271585 (FIG. 1)

Patent Document 11: Japanese Patent Publication No. 3575508 (FIG. 1)

### DISCLOSURE OF THE INVENTION

### Problems to be Solved by the Invention

However, a video decoding device having the recompression unit disclosed in Patent Documents 1 to 11 may cause significant deterioration of the picture quality.

The causes of deterioration of the picture quality will be described using a specific example.

A frame average luminance signal PSNR in the case of using an video sequence different from the above-described video sequence is shown in FIG. 6.

In FIG. 6, a difference between PSNR of an intra prediction frame and PSNR immediately preceding the intra prediction frame is 10 dB or more near 60 to 120 frames and near 270 to 300 frames (encircled portions in FIG. 6).

The grounds that PSNR drops relate to the coding system of the recompression block. For example, H.264 bitstream in which an image shown in FIG. 7 is coded in a coding mode shown in FIG. 8 will be considered.

The image shown in FIG. 7 has black pixels for 15 consecutive pixels from the end of the image, and the original image starts from the 16^{th} pixel. Further, an inter- (between frames) prediction frame in the H.264 bitstream is coded such that an MB at the left end of the image is coded as an inter prediction MB of a still image, an MB on the immediately right side is coded as an intra prediction MB, and the prediction mode is coded as horizontal direction prediction as shown in FIG. 9.

In H.264, although there are a plurality of block sizes which are objects of the intra prediction mode and the intra prediction, in order to simplify the description, horizontal direction prediction of a block size of 16*16 is used. Operation when a luminance signal of the H.264 bitstream is recompressed and extended is shown in FIG. 10.

In the intra prediction frame, 1-D DPCM compression is performed to a general decoded pixel. In this example, the pixel value largely changes from the 15^{th} pixel to the 16^{th} pixel. In general, as non-linear quantization is designed such that distortion is allowed if a prediction error value is large, a large distortion caused by recompression is mixed to the 16^{th} pixel.

As there are a large number of black pixels in an MB at the left end of the image of the inter prediction frame, it is coded as a still image. Consequently, an MB at the same location in the intra prediction frame is used as a reference pixel. As the MB on the immediately right side is intra prediction MB and horizontal direction prediction, a row of the 16^{th} pixel of the MB at the left end of the image becomes a reference pixel. In this case, the reference pixel of this MB includes distortion caused by recompression due to recompression and extension of the intra prediction frame. As a result, if a prediction image is generated in the horizontal direction prediction as shown in FIG. 9, the distortion caused by recompression will propagate across the MB.

In this way, as a peripheral pixel is used as a reference pixel in the intra prediction, distortion caused by recompression propagates not only in the MB but also spatially if the intra prediction MB continues.

Further, when the inter prediction frame is used as a reference frame, distortion also propagates temporarily. As a result, the picture quality deteriorates significantly.

As such, a problem of a video decoding device having a conventional recompression unit is that recompression is performed such that distortion in each recompression processing unit becomes the minimum without considering temporal and spatial propagation of distortion.

The present invention has been developed in view of the above-described problems. It is an object of the present invention to provide a video decoding device and a decoded image recording device, having a recompression unit capable of suppressing temporal and special propagation of distortion caused by recompression, that is, deterioration in image quality, and their methods and programs.

### Means for Solving the Problems

The present invention which solves the above-described problems is a video decoding device including: a decoding unit which decodes a video bitstream which is coded using prediction processing into an image signal; a recompression unit which performs recompression processing on the image signal decoded by the decoding unit by performing quantization in which different numbers of bits are allocated to respective pixels or respective recompression processing units to thereby acquire recompressed data; a prediction frame memory unit which stores the recompressed data acquired by the recompression unit; an extension unit which reads out the recompressed data stored in the prediction frame memory unit, and after extending the recompressed data, supplies the data as data to be used in the prediction processing performed by the decoding unit; and an address control unit which controls writing or reading of the recompressed data to or from the prediction frame memory. The recompression unit is configured to determine a reference degree of each pixel or a reference degree of each recompression processing unit according to a pixel position to be referred to in prediction processing in the coding system, and controls a recompressed data amount such that a number of allocated bits indicating a quantization representative value becomes larger with respect to a pixel having a high reference degree or a recompression processing unit having a high reference degree.

The present invention which solves the above-described problems is a decoded image recoding method for generating a prediction image of a prediction image coding decoding method, including: when a decoded image is compressed to be recorded, estimating frequency that a region of the decoded image is referred to in prediction; and compressing a region of a decoded image having a higher reference degree with higher accuracy than that of a region of a decoded image having lower reference degree.

The present invention which solves the above-described problems is a program for recording a decoded image for generating a prediction image of a prediction image coding decoding method. The program causes an information processing device to execute: when compressing and recording a decoded image, processing to estimate frequency that a region of the decoded image is referred to in prediction; and processing to compress a region of a decoded image having a higher reference degree with higher accuracy than that of a region of a decoded image having a lower reference degree.

The present invention which solves the above-described problems is a decoded image recording device for generating a prediction image of a prediction image coding decoding method, including: a compression unit which, when compressing and recording a decoded image, estimates frequency that a region of the decoded image is referred to in prediction, and compresses a region of a decoded image having higher reference frequency with higher accuracy than that of a region of a decoded image having lower reference frequency.

The present invention which solves the above-described problems is a video decoding method for performing recompression processing on a decoded image signal by performing quantization in which different numbers of bits are allocated to respective decoded image signals or respective recompression processing units to thereby acquire recompressed data. The method includes: determining a reference degree of each pixel or a reference degree of each recompression processing unit according to a pixel position to be referred to in prediction processing in a coding system, and controlling a recompressed data amount such that a number of allocated bits indicating a quantization representative value becomes larger with respect to a pixel having a high reference degree or a recompression processing unit having a high reference degree.

The present invention which solves the above-described problems is a program in a video decoding method for performing recompression processing on a decoded image signal by performing quantization in which different numbers of bits are allocated to respective pixels or respective recompression processing units, to thereby acquire recompressed data. The program causes an information processing device to execute: processing to determine a reference degree of each pixel or a reference degree of each recompression processing unit according to a pixel position to be referred to in prediction processing in a coding system, and controlling a recompressed data amount such that a number of allocated bits indicating a quantization representative value becomes larger with respect to a pixel having a high reference degree or a recompression processing unit having a high reference degree.

The video decoding device of the present invention has a reference degree weighting recompression block 102 in which feasibility of referring to a certain pixel position within a frame from a pixel position to be referred to in a coding system which is an object of the decoding device is set. As such, the reference degree weighting recompression block 102 performs recompression with a control to increase the number of allocated bits of a quantization representative value (number of quantization representative values) with respect to a pixel which is easily referred to.

In this case, reference feasibility may be set by using, in addition to a pixel position to be referred to in the coding system, at least one of a coding processing unit of the coding system which is an object of a decoding device, a pixel position to be referred to in a coding system which is an object of the reference degree weighting recompression block, a recompression processing unit, and a compression rate.

### EFFECT OF THE INVENTION

An effect of the present invention is to provide a video decoding device having a recompression unit capable of suppressing distortion caused by recompression, that is, deterioration in picture quality.

This is because, as a reference degree weighting recompression block 102 is mounted while reference feasibility of a certain pixel position within a frame from a pixel position to be referred to in a coding system which is an object of a decoding device has been set beforehand, recompression is performed with a control to increase the number of allocated bits of a quantization representative value for a pixel which is easily referred to. Consequently, it is possible to reduce distortion of a pixel which is easily referred to, and to suppress temporal and spatial propagation of distortion.

In this case, reference feasibility may be set by using, in addition to a pixel position to be referred to in a coding system, at least one of a coding processing unit of a coding system which is an object of the decoding device, a pixel position to be referred to in a coding system which is an object of the reference degree weighting recompression block, a recompression processing unit, and a compression rate.

As an actual effect of the present invention, FIG. 18 shows a frame average luminance signal PSNR in which the results of Examples 1 and 3 are added to the result shown in FIG. 6. In FIG. 18, “Embodiment 1” indicates the Example 1, and “Embodiment 3” indicates the Example 3. A coding unit X has 8 pixels, and it is set such that the reference degree R0 is 8 and the reference degree R1 is 5. X, R0, and R1, will be described in detail in the description of a mode for carrying out the present invention.

From the drawings, it is understood that deterioration in PSNR is suppressed in the present invention.

### BEST MODE FOR CARRYING OUT THE INVENTION

Next, a mode for carrying out the present invention will be described in detail with reference to the drawings.

FIG. 1 is a block diagram showing the overall configuration of a video decoding device according to a mode of the present invention.

The video decoding device of the present exemplary embodiment includes a decoding block 101, a reference degree weighting recompression block 102, a prediction frame memory block 103, an extension block 104, and an address control block 105. This decoding device is configured such that the recompression block 202 of a conventional video decoding device is replaced with the reference degree weighting recompression block 102.

The decoding block 101 decodes a video bitstream, which is coded using prediction processing, to an image signal.

The reference degree weighting recompression block 102, which is used as a recompression unit, performs recompression processing on the decoded image signal acquired from the decoding block 101 by performing quantization in which the different numbers of bits are allocated to respective pixels or to respective recompression processing units, to thereby acquire recompressed data. The reference degree weighting recompression block 102 determines a reference degree of each pixel or a reference degree of each recompression processing unit according to the pixel position to be referred in prediction processing in the coding system, and performs a recompressed data amount control such that the allocated number of bits indicating the quantization representative value becomes larger to a pixel having a high reference degree or to a recompression processing unit having a high reference degree.

The prediction frame memory block 103 stores the recompressed data acquired by the reference degree weighting recompression block 102. The extension block 104 reads out the recompressed data stored in the prediction frame memory block 103, and after extending the data, supplies it as data to be used in prediction processing by the decoding block 101. The address control block 105 controls writing or reading of the recompressed data to/from the prediction frame memory block 103.

In this mode, the reference degree indicates feasibility of referencing a certain pixel position within the frame (frequency of being used for prediction). An accurate reference degree may be calculated by analyzing the coded video bitstream. However, in the present mode, a reference degree is estimated and determined in advance from the pixel position to be referred to in the coding system which is an object of the decoding device.

The reference degree weighting recompression block 102 operates in the same manner as the recompression block 202 in the aspect of recompressing a decoded image. However, the coding system which is an object of the reference degree weighting recompression block 102 is designed and provided while taking into account the estimated reference degree. Note that the reference degree may be set using, in addition to the pixel position to be referred to in the coding system, one or more of a coding processing unit of the coding system which is an object of the decoding device, a pixel position to be referred to in the coding system which is an object of the reference degree weighting recompression block 102, a recompression processing unit, and a compression rate.

Next, operation of the video decoding device of the present mode will be described.

Note that as the decoding block 101, the prediction frame memory block 103, the extension block 104, and the address control block 105 operate in the same manner as a video decoding device having a conventional recompression unit, the explanation is omitted.

The reference degree weighting recompression block 102 recompresses a decoded image which is decoded by the decoding block 101 to thereby generate recompressed data. In this mode, as the reference degree weighting recompression block 102 is provided while taking into account the reference degree, the reference degree weighting recompression block 102 recompresses the data by applying a recompressed data amount control such that the number of allocated bits of the quantization representative value becomes larger with respect to a pixel value having a high reference degree.

### EXAMPLE 1

Next, configuration and operation of the best mode for carrying out the present invention will be described using specific examples.

In this example, H.264 is used as the decoding block 101, and 1-D DPCM is used as a coding system of the reference degree weighting recompression block 102.

Here, in 1-D DPCM, X pixels configure a recompression processing unit. The value of X is determined according to a coding processing unit of H.264 and easiness of mounting. For example, as 2, 4, 8, and 16 may be used as a coding processing unit of H.264, any of them is selected considering the easiness of mounting.

The reference degree is determined from Formula 1 (Expression 1).

### [Expression 1]

Horizontal pixel position is Xn+(X−1) R0
Other than above R1
where n is an integer of 0 or larger.

This reference degree takes into account the pixel position to be referred to in H.264 that “the left block of the intra prediction coding object block is used as a reference pixel”, and satisfies R0>R1.

In the 1-D DPCM used for the reference degree weighting recompression block 102, the reference degree is directly used as the number of allocated bits of the quantization representative value. In that case, the compression ratio of the reference degree weighting recompression block depends on R0 and R1.

FIG. 11 shows the number of allocated bits of the quantization representative value and reference relationship of the present example.

In the present example, the right end pixel of a recompression processing unit is set to be the starting point of a prediction pixel, and the right pixel is set to be a prediction pixel.

In the case of using the present example in which the X value is 2, 4, 8, or 16, as shown in FIG. 12, the number of allocated bits of a quantization representative value with respect to a peripheral pixel serving as a reference pixel of each MB (Macroblock) is set to be R0.

As a result, distortion to be caused by recompression can be prevented in the cases shown in FIGS. 7, 8, 10 and the like.

Further, although two reference degrees are determined within a recompression processing unit in the present example, a reference degree may be determined for each pixel.

In that case, considering the prediction pixel position that the “right pixel of 1-D DPCM is set to be a prediction pixel” in setting the reference degree, as propagation of distortion becomes smaller in a part closer to the left end pixel, it is possible to set the reference degree to be larger for righter pixels in the recompression processing unit.

Further, although the right pixel is set to be a prediction pixel in the present example and the left pixel is set to be a prediction pixel in FIG. 4, an upper pixel or a lower pixel may be set to be a prediction pixel. However, if considering the reference pixel position in H.264 that “a block above the intra prediction coding object block is used as a reference pixel”, a reference degree which is the same as that of Formula 1 (Expression 1) with respect to the vertical pixel position is set such that the lower pixel is set to be a prediction pixel.

### EXAMPLE 2

In the Example 1, a right pixel is set to be a prediction pixel. In the case of raster scan display using the coding system of Example 1, decoded images are required to be stored temporarily in order to be aligned in the display order, which may not be desirable in practice. As such, a reference degree is defined by Formula 2 (Expression 2) in Example 2.

### [Expression 2]

Horizontal pixel position is 0 or Xn+(X−1) R0
Other than above R1
where n is an integer of 0 or larger.

With use of the reference degree defined in Formula 2 (Expression 2), it is possible to shift the horizontal position of a pixel in which the reference degree is R0, whereby the same effect as that of the first example can be achieved while the left pixel is a prediction pixel.

FIG. 13 shows the number of allocated bits of a quantization representative value where X is 8 and the reference relationship in Example 2.

The number of allocated bits of a peripheral pixel serving as a reference pixel of each MB (Macroblock) is the same as that in FIG. 12.

### EXAMPLE 3

The above-described Examples 1 and 2 will be effective if a block including a reference pixel is coded as a still image, as shown in FIGS. 7, 8 and 10. In general, however, not all of the blocks are coded as a still image, so there may be the same problem as the case of a video decoding device having a conventional recompression unit. As such, in Example 3, a reference degree is set such that a possibility of including a reference pixel in which the number of allocated bits is R0 becomes high in the block which is referred to for inter prediction.

Specifically, it is determined such that the reference degree will not become equal to that of a laterally or vertically adjacent pixel. As an example, a reference degree is set by Formula 3 (Expression 3).

### [Expression 3]

Even number line
Horizontal pixel position is Xn+(X−1) R0
Other than above R1
Odd number line
Horizontal pixel position is Xn R0
Other than above R1
where n is an integer of 0 or larger.

FIG. 14 shows the number of allocated bits of a quantization representative value and the reference relationship in Example 3.

In the case of using the present example where X=2, 4, 8, 16, R0(>R1) bits are allocated to a peripheral pixel serving as a reference pixel of each MB (Macroblock) as shown in FIG. 15.

If a still image block is referred to in the inter prediction, the number of reference pixels in which the number of allocated bits is R0 is reduced compared with the case shown in FIG. 12. However, considering typical inter prediction, the possibility of including reference pixels where the allocated number of bits is R0 in the reference block becomes high.

Although a reference degree and reference relationship are set for each line in this exemplary embodiment, it is also possible to set for X types as shown in Formula 4 (Expression 4) and FIG. 16.

### [Expression 4]

0 line
Horizontal pixel position is Xn R0
Other than above R1
1 line
Horizontal pixel position is Xn+1 R0
Other than above R1
X−1 line
Horizontal pixel position is Xn+(X−1) R0
Other than above R1
where n is an integer of 0 or larger.

In the present example, Note that the same effect can be obtained with respect to reference pixels of not only intra prediction but also inter prediction. As such, it is possible to use a coding system using inter prediction other than H.264 as the decoding block 101.

### EXAMPLE 4

In Examples 1 to 4 above, 1-D DPCM has been used as the coding system of the reference degree weighting recompression block 102.

In the present invention, as any desired system can be used as a coding system, two-dimensional DPCM (2-D DPCM) is used as a coding system in this example.

In 2-D DPCM, a block composed of lateral X pixels by vertical Y pixels is used as a recompression processing unit. The values of X and Y are determined from the coding processing unit, the compression rate, easiness of mounting and the like of H.264. As such, 2, 4, 8, and 16 may be used. The reference degree is determined by Formula 5 (Expression 5).

### [Expression 5]

Horizontal pixel position is Xn+(X−1) and
vertical pixel position is Yn+(Y−1) R0
Other than above R1
where n is an integer of 0 or larger.

This reference degree takes into account pixel position to be referred to in H.264 in which “the left block to the coding object block is used as a reference pixel” and “the upper block of the intra prediction cording object block is used as a reference pixel”.

In 2-D DPCM used for the reference degree weighting recompression block 102, the reference degree is directly used as the number of allocated bits of a quantization representative value, as the case of 1-D DPCM.

FIG. 17 shows the number of allocated bits of a quantization representative value and the reference relationship of the present example.

In the present example, the right lower end pixel of a recompression processing unit is set to be the starting point of a prediction pixel, and for pixels using 1-D DPCM, a right or lower pixel is set to be a prediction pixel, and for pixels using 2-D DPCM, three pixels, that is, right, lower, and lower right pixels are set to be prediction pixels.

### EXAMPLE 5

As obvious from the above description, the video decoding device according to the present invention can be configured as hardware, while it can also be configured as computer programs.

FIG. 19 is a typical block diagram showing an information processing system in which the video decoding device of the present invention is implemented.

The information processing system shown in FIG. 19 includes a processor 400, a program memory 401, and a storage medium 402. The storage medium 402 may be a separate storage medium, or a storage region in the same storage medium. As the storage medium, a magnetic storage medium such as RAM or a hard disk can be used, which serves as the prediction frame memory block 103.

The program memory 401 stores programs for causing the processor 400 to perform processing of respective blocks including the decoding block 101, the reference degree weighting recompression block 102, the extension A block 104, and the address control block 105. With these programs, the processor 400 operates.

In this way, the present invention can be realized with computer programs.

Note that not all of the decoding block 101, the reference degree weighting recompression block 102, the extension A block 104, and the address control block 105 are required to be operated by the programs. A part thereof may be configured of hardware.

Applications of the present invention include digital video decoding devices such as a digital broadcast tuner, an HDD recorder, and a DVD player.

### BRIEF DESCRIPTION OF THE DRAWINGS

FIG. 1 is a block diagram showing the configuration of a mode of the present invention.

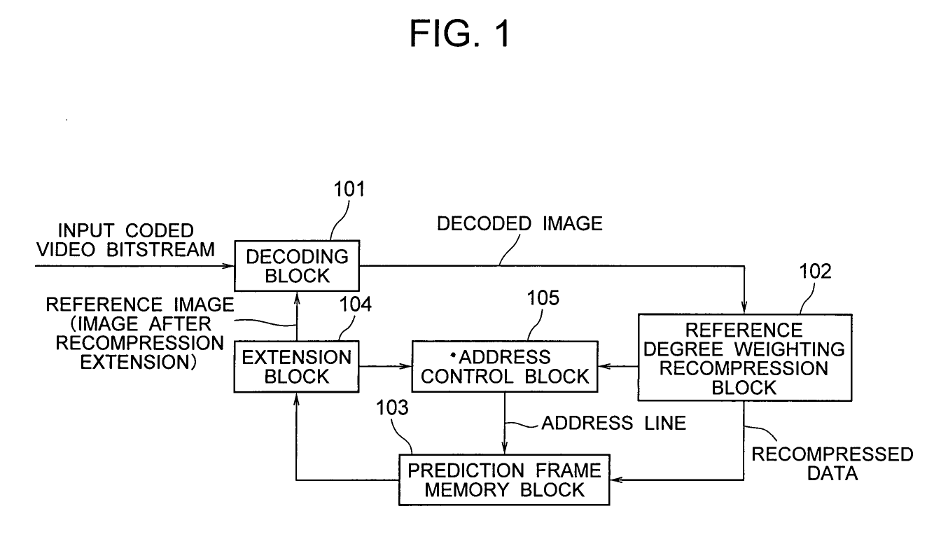

FIG. 2 is a block diagram showing the configuration of a video decoding device disclosed in Patent Document 1.

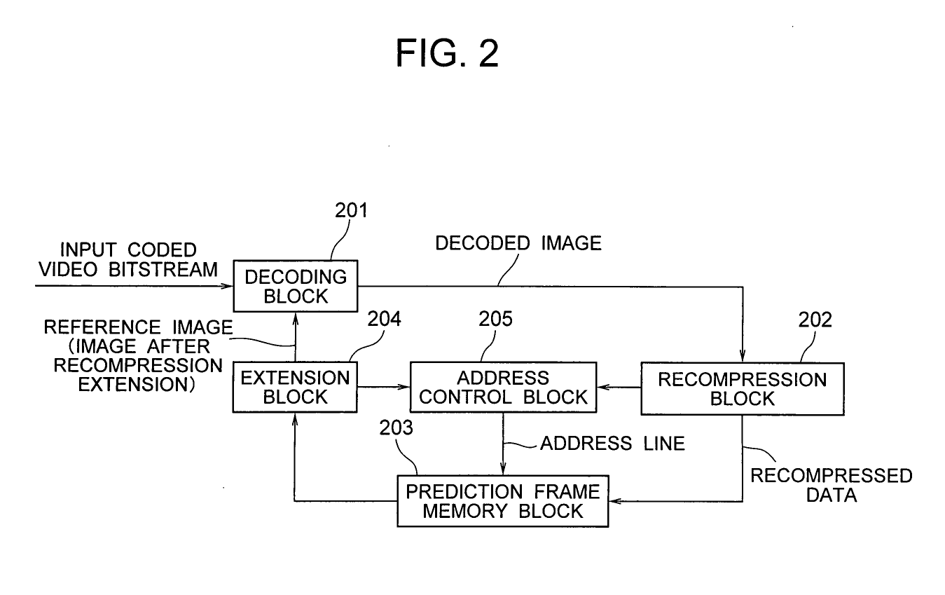

FIG. 3 is a block diagram showing an exemplary configuration using H.264 in the video decoding device disclosed in Patent Document 1.

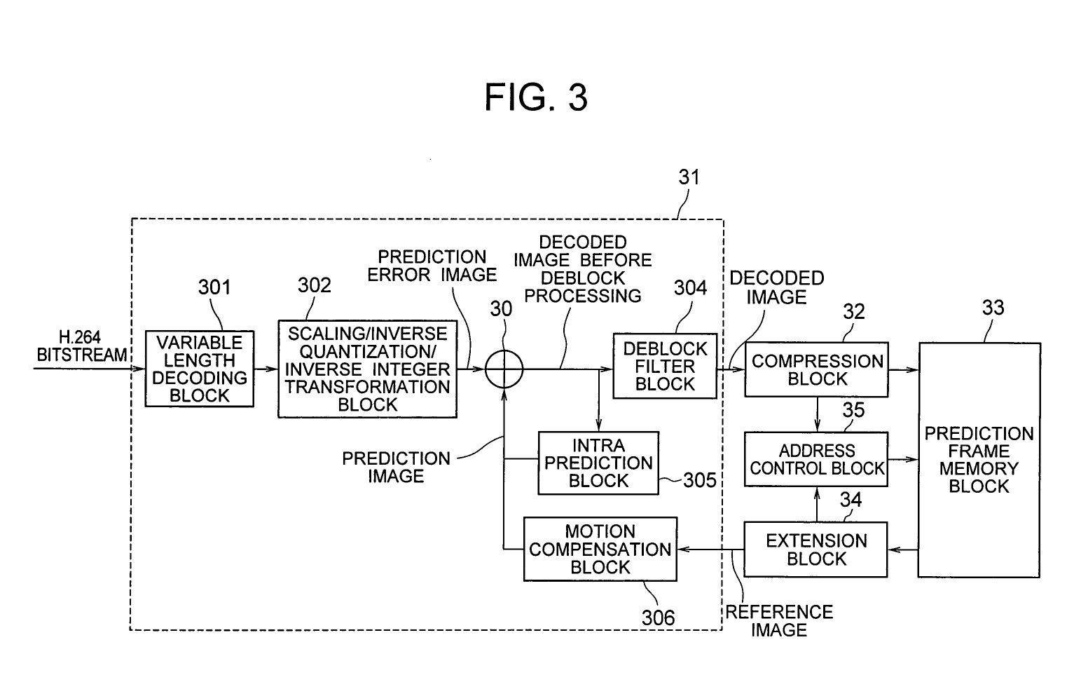

FIG. 4 is a drawing showing an example of a coding system to be used for recompression of a decoded image.

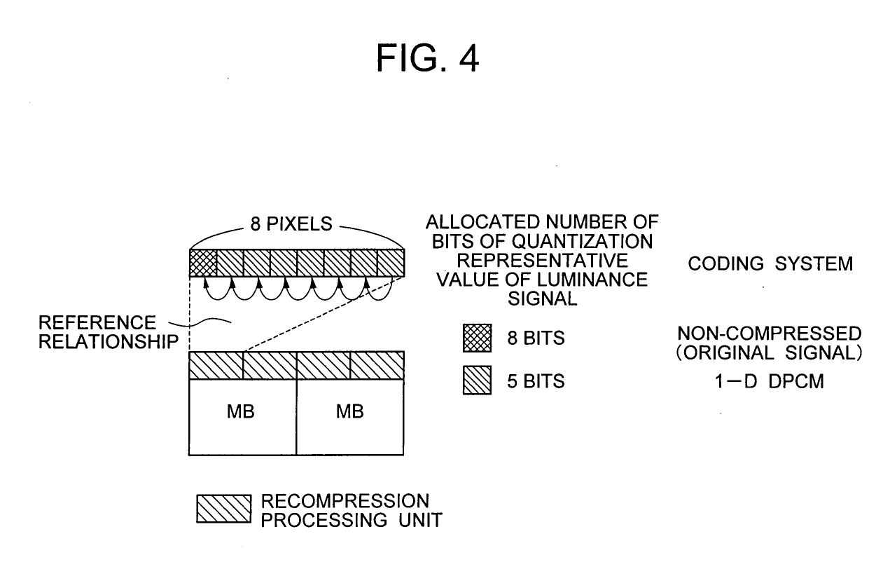

FIG. 5 is a graph showing an effect of a conventional video decoding device.

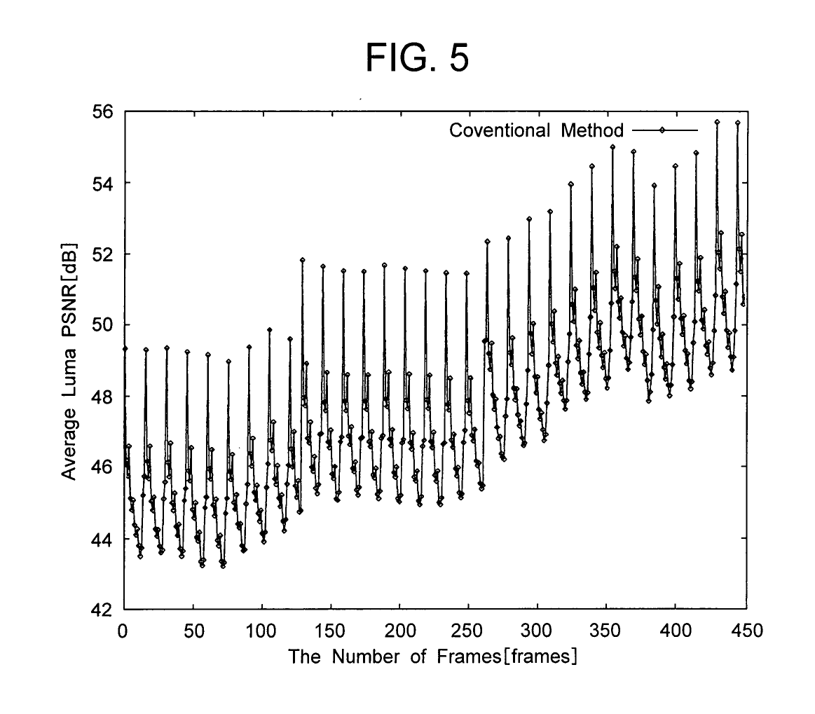

FIG. 6 is a graph showing a problem of a conventional video decoding device.

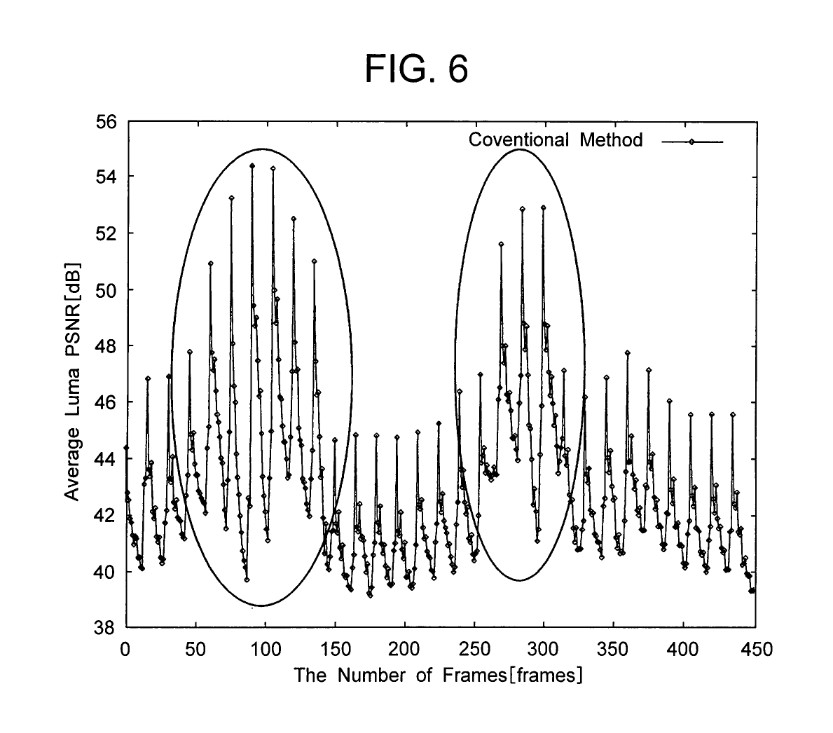

FIG. 7 is a specific example for illustrating a problem of a conventional video decoding device.

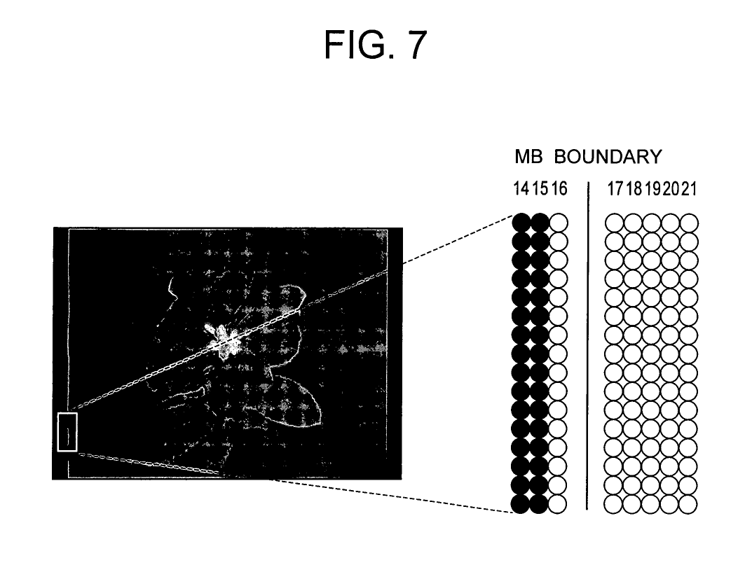

FIG. 8 is a specific example for illustrating a problem of a conventional video decoding device.

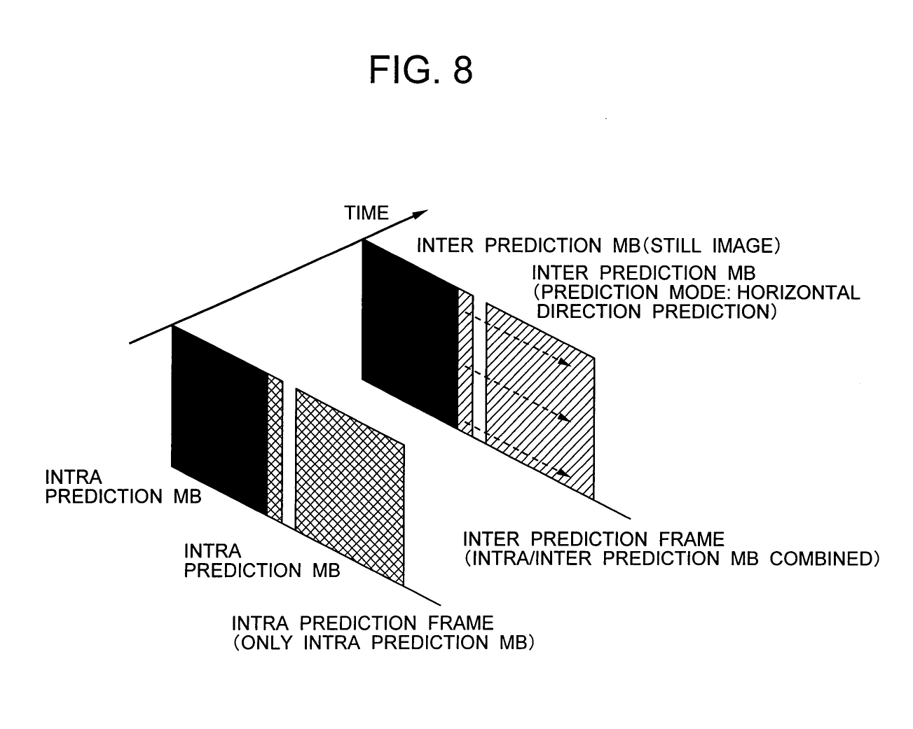

FIG. 9 is a drawing illustrating H.264 intra prediction mode.

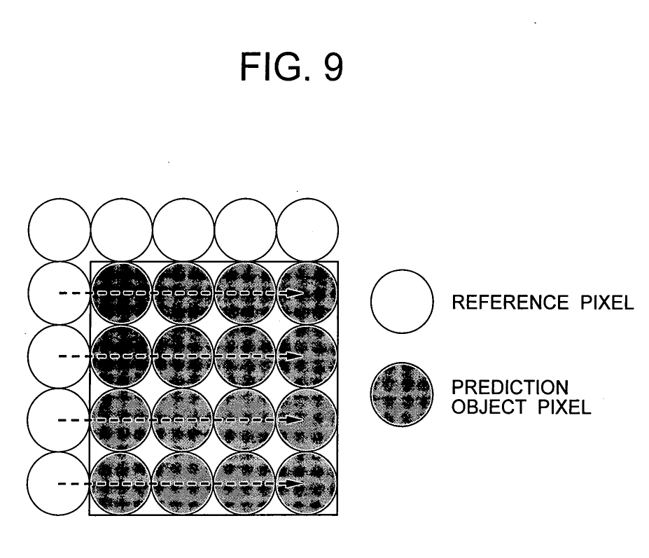

FIG. 10 is a drawing illustrating a cause of distortion by recompression.

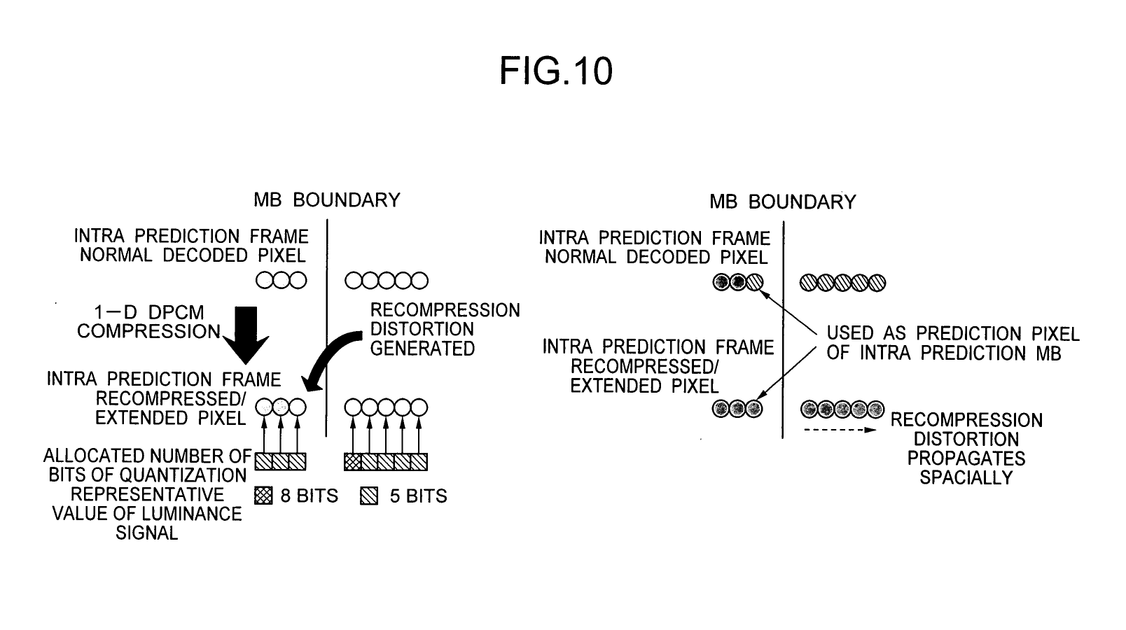

FIG. 11 is a drawing showing the number of allocated bits of a quantization representative value of each pixel position and reference relationship in Example 1.

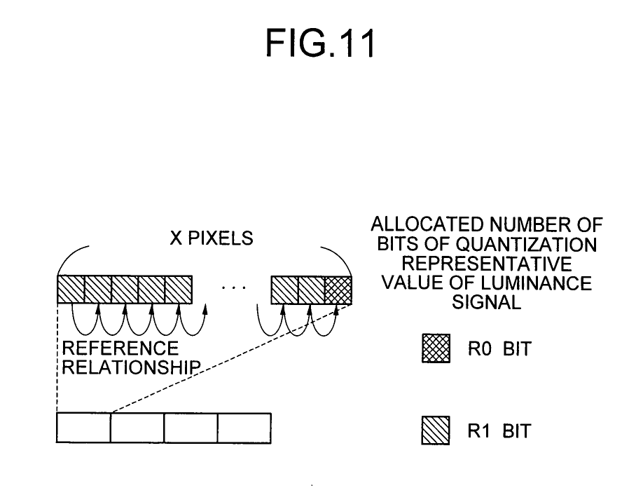

FIG. 12 is a drawing showing the number of allocated bits of a quantization representative value near an MB boundary in Example 1.

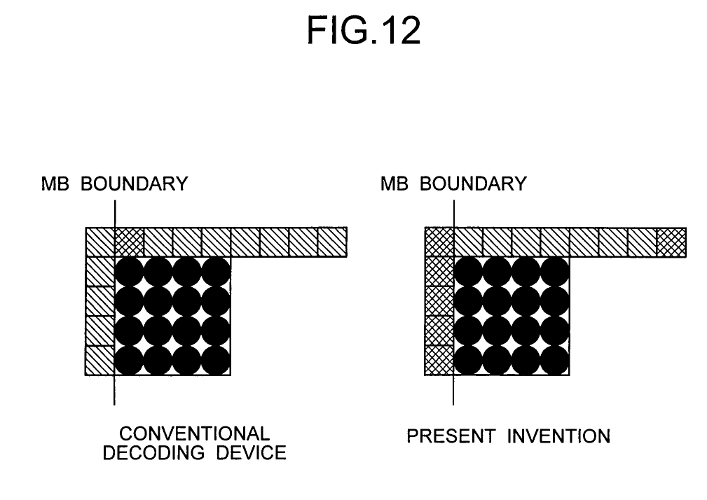

FIG. 13 is a drawing showing the number of allocated bits of a quantization representative value of each pixel position and reference relationship in Example 2.

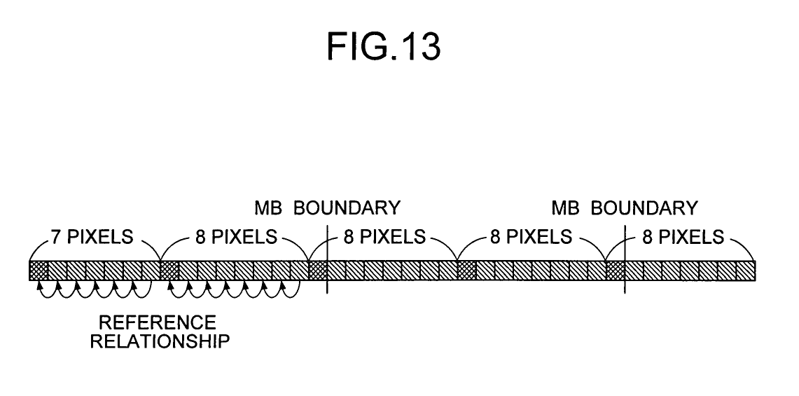

FIG. 14 is a drawing showing the number of allocated bits of a quantization representative value of each pixel position and reference relationship in Example 3.

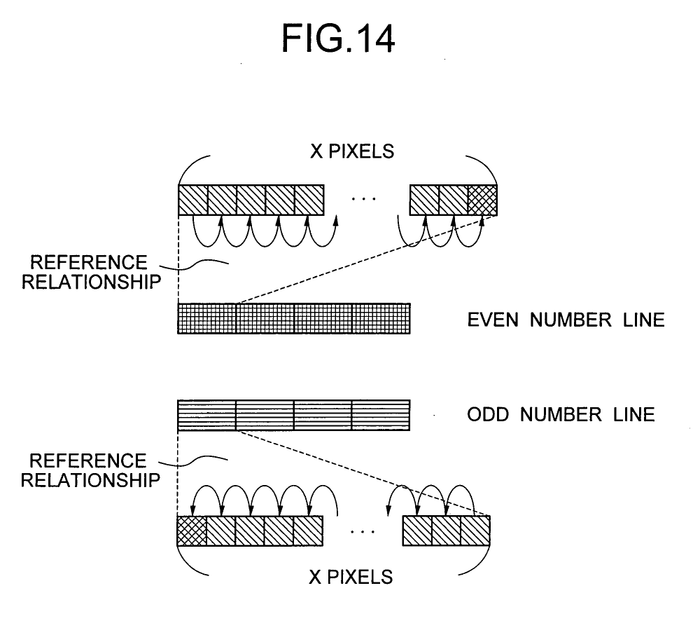

FIG. 15 is a drawing showing the number of allocated bits of a quantization representative value near an MB boundary in Example 3.

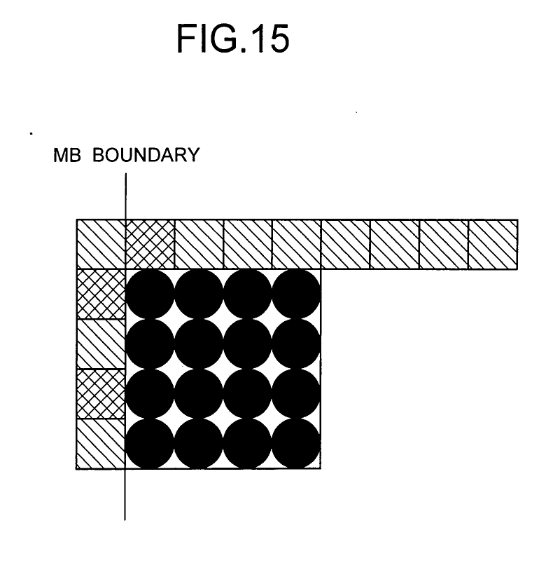

FIG. 16 is a drawing showing the number of allocated bits of a quantization representative value of each pixel position and reference relationship in Example 3.

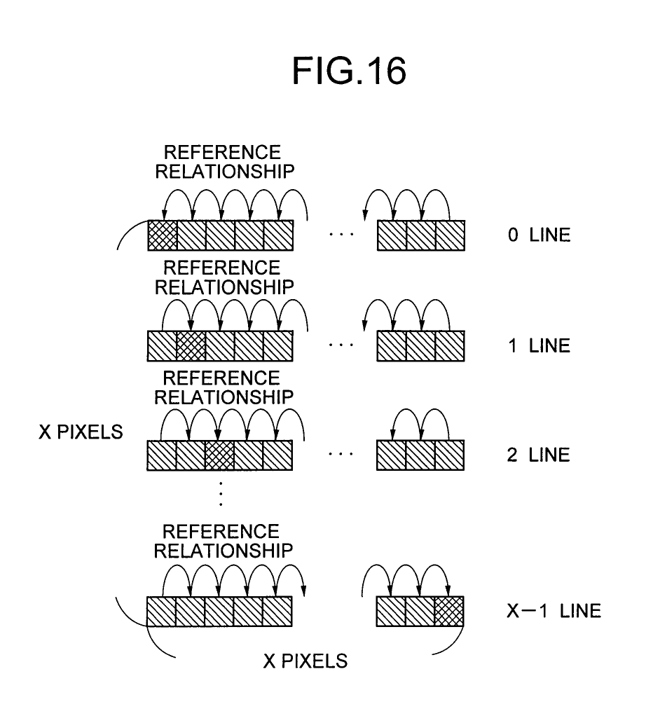

FIG. 17 is a drawing showing the number of allocated bits of a quantization representative value of each pixel position and reference relationship in Example 4.

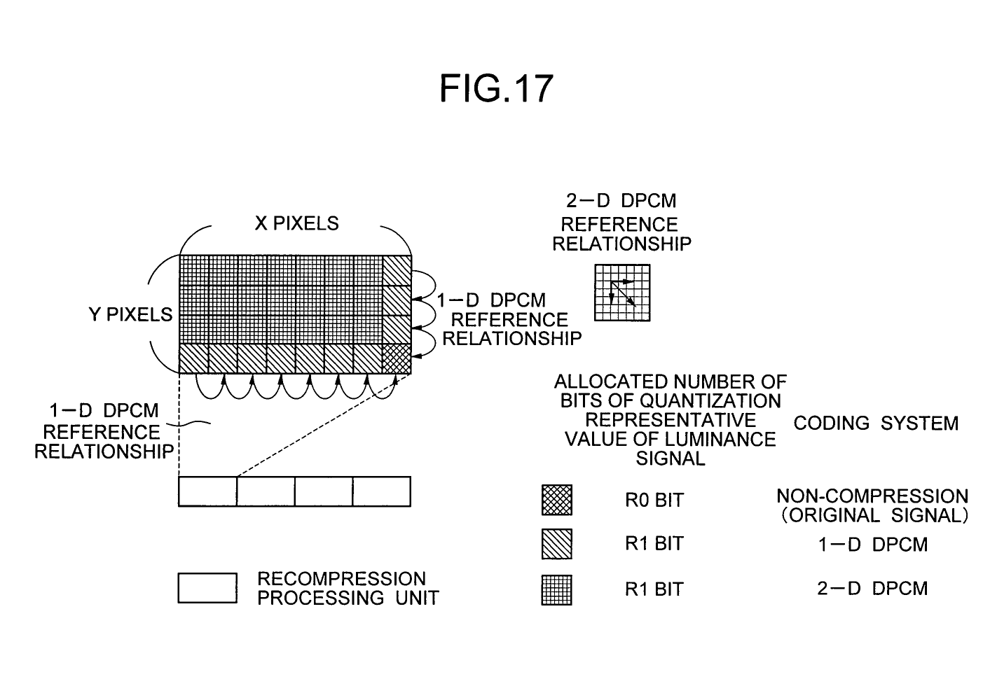

FIG. 18 is a graph showing effects of the present invention (Examples 1 and 3).

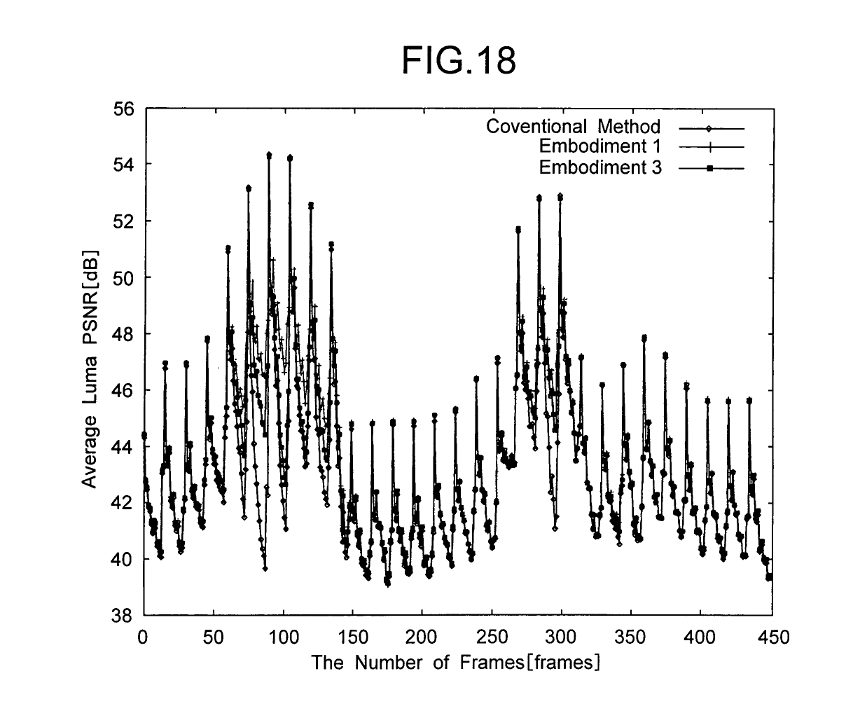

FIG. 19 is a typical block diagram of an information processing system in which the video decoding device of the present invention is implemented.

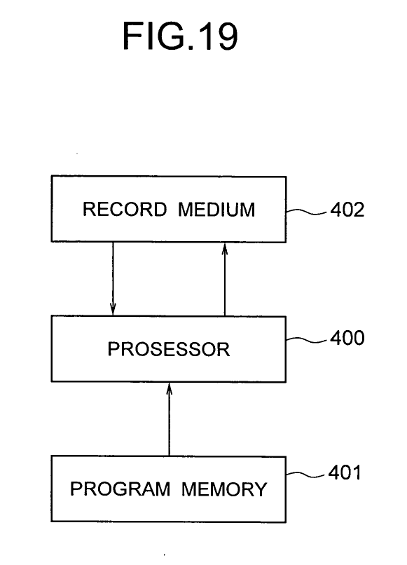

### DESCRIPTION OF REFERENCE NUMERALS

101, 201, 31 decoding block
102 reference degree weighting recompression block
202, 32 recompression block
103, 203, 33 prediction frame memory block
104, 204, 34 extension A block
105, 205, 35 address control block
106 reference degree information
301 variable length decoding block
302 scaling/inverse quantization/inverse integer transformation block
303 adder block
304 deblock filter block
305 intra prediction block
306 motion compensation block

1-26. (canceled)

27. A video decoding device comprising:
a decoding unit for decoding a video bitstream which is coded by a coding system using intra prediction processing and inter-frame prediction processing into an image signal;
a recompression unit for performing recompression processing on the image signal decoded by the decoding unit by performing quantization in which different numbers of bits are allocated to respective pixels or respective recompression processing units to thereby acquire recompressed data;
a prediction frame memory unit for storing the recompressed data acquired by the recompression unit;
an extension unit for reading out the recompressed data stored in the prediction frame memory unit, and after extending the recompressed data, supplying the data as data to be used in prediction processing performed by the decoding unit; and
an address control unit for controlling writing or reading of the recompressed data to or from the prediction frame memory unit, wherein
the recompression unit is configured to determine a reference degree of each pixel or a reference degree of each recompression processing unit according to a pixel position to be referred to in the intra prediction processing in the coding system, control a recompressed data amount such that a number of allocated bits indicating a quantization representative value becomes larger with respect to a pixel having a high reference degree or a recompression processing unit having a high reference degree, and suppress accumulation of errors caused in recompression processing.

28. The video decoding device, according to claim 27, wherein the reference degree is determined using at least one of a coding processing unit of the coding system, a pixel position to be referred to in generating a prediction image by the recompression unit, the recompression processing unit of the recompression unit, and compression rate of the recompression unit.

29. The video decoding device, according to claim 27, wherein the recompression unit is configured to perform quantization of a reference pixel which is one of pixels in the recompression processing unit, and perform quantization with respect to a difference between adjacent pixels for pixels other than the reference pixel.

30. The video decoding device, according to claim 29, wherein a maximum reference degree in the recompression processing unit of the recompression unit is determined so as not to be equal to a reference degree of a vertically or laterally adjacent pixel.

31. A video decoding device comprising:
a decoding means for decoding a video bitstream which is coded by a coding system using intra prediction processing and inter-frame prediction processing into an image signal;
a recompression means for performing recompression processing on the image signal decoded by the decoding means by performing quantization in which different numbers of bits are allocated to respective pixels or respective recompression processing units to thereby acquire recompressed data;
a prediction frame memory means for storing the recompressed data acquired by the recompression means;
an extension means for reading out the recompressed data stored in the prediction frame memory means, and after extending the recompressed data, supplying the data as data to be used in prediction processing performed by the decoding means; and
an address control means for controlling writing or reading of the recompressed data to or from the prediction frame memory means, wherein
the recompression means is configured to determine a reference degree of each pixel or a reference degree of each recompression processing unit according to a pixel position to be referred to in the intra prediction processing in the coding system, control a recompressed data amount such that a number of allocated bits indicating a quantization representative value becomes larger with respect to a pixel having a high reference degree or a recompression processing unit having a high reference degree, and suppress accumulation of errors caused in recompression processing.

32. A decoded image compressing and recoding method for generating a prediction image of a prediction image coding decoding method, comprising:
when the compressing and recording, estimating frequency that a region of the decoded image is referred to in prediction of the prediction image coding decoding method; and
compressing a region of a decoded image having a higher reference degree with higher accuracy than that of a region of a decoded image having lower reference degree.

33. The decoded image recording method, according to claim 32, wherein estimation of the frequency that the region of the decoded image is referred to in prediction is estimated by a number of pixel positions to be referred to in prediction within the region of the decoded image.

34. The decoded image recording method, according to claim 33, wherein the prediction image coding decoding method is a prediction image coding decoding method using intra prediction, and
the pixel position to be referred to in the prediction is a pixel position to be referred to in generating an intra prediction image.

35. The decoded image recording method, according to claim 32, wherein estimation of the frequency that the region of the decoded image is referred to in prediction is estimated using at least one of a prediction image coding processing unit of the prediction image coding decoding method, a pixel position to be referred to in generating a prediction image in a decoded image compression method, a compression processing unit of a decoded image compression method, and a compression rate of a decoded image compression method.

36. The decoded image recording method, according to claim 35, wherein the compression method of the decoded image includes performing quantization to a reference pixel which is one of pixels in the compression processing unit, and performing quantization with respect to a difference between adjacent pixels for pixels other than the reference pixel.

37. A program which causes a computer to execute, the computer constituting an information processing device for recording a decoded image for generating a prediction image in a prediction image coding decoding method,
a function of decoding a video bitstream which is coded by a coding system using intra prediction processing and inter-frame prediction processing into an image signal,
function of performing recompression processing on the decoded image signal by performing quantization in which different numbers of bits are allocated to respective pixels or respective recompression processing units, and
a function of determining a reference degree of each pixel or a reference degree of each recompression processing unit according to a pixel position to be referred to in the intra prediction processing in the coding system, controlling a recompressed data amount such that a number of allocated bits indicating a quantization representative value becomes larger with respect to a pixel having a high reference degree or a recompression processing unit having a high reference degree, and suppressing accumulation of errors caused in recompression processing.

38. The program, according to claim 37, which causes the computer to execute,
when the compressing and recording the decoded image, processing to estimate frequency that a region of the decoded image is referred to in prediction of the prediction image coding and decoding method, and
processing to compress a region of a decoded image having a higher reference degree with higher accuracy than that of a region of a decoded image having a lower reference degree.

39. The program, according to claim 37, wherein in the processing to estimate the frequency that the region of the decoded image is referred to in prediction, estimation is performed with a number of pixel positions to be referred to in the prediction within the region of the decoded image.

40. The program, according to claim 39, wherein the prediction image coding decoding method is a prediction image coding decoding method using intra prediction, and
the pixel position to be referred to in the prediction is a pixel position to be referred to when an intra prediction image is generated.

41. The program, according to claim 38, wherein the processing to estimate the frequency that the region of the decoded image is referred to in prediction is estimated using at least one of a prediction image coding processing unit of the prediction image coding decoding method, a pixel position to be referred to in generating a prediction image in a decoded image compression method, a compression processing unit of a decoded image compression method, and a compression rate of a decoded image compression method.

42. The program, according to claim 41, wherein the compression method of a decoded image includes performing quantization of a reference pixel which is one of pixels in the compression processing unit, and performing quantization with respect to a difference between adjacent pixels for pixels other than the reference pixel.

43. A decoded image compressing and recording device for generating a prediction image of a prediction image coding decoding method, comprising:
a compression unit for, when the compressing and recording, estimating frequency that a region of the decoded image is referred to in prediction of the prediction image coding decoding method, and compressing a region of a decoded image having higher reference frequency with higher accuracy than that of a region of a decoded image having lower reference frequency.

44. The decoded image recording device, according to claim 43, wherein the compression unit estimates the frequency that the region of the decoded image is referred to in prediction according to a number of pixel positions to be referred to in prediction within the region of the decoded image.

45. The decoded image recording device, according to claim 44, wherein the prediction image cording decoding method is a prediction image coding decoding method using intra prediction, and
a pixel position to be referred to in the prediction is a pixel position to be referred to when an intra prediction image is generated.

46. The decoded image recording device, according to claim 43, wherein the compression unit estimates frequency that a region of the decoded image is referred to in prediction using at least one of a prediction image coding processing unit of the prediction image coding decoding method, a pixel position to be referred to when a prediction image is generated in a decoded image compression method, a compression processing unit of a decoded image compression method, and a compression rate of a decoded image compression method.

47. The decoded image recording device, according to claim 44, wherein the decoded image compression method includes performing quantization of a reference pixel which is one of pixels in the compression processing unit, and performing quantization with respect to a difference between adjacent pixels for pixels other than the reference pixel.

48. A decoded image compressing and recording means for generating a prediction image of a prediction image coding decoding method, comprising:
a compression means for, when the compressing and recording, estimating frequency that a region of the decoded image is referred to in prediction of the prediction image coding decoding method, and compressing a region of a decoded image having higher reference frequency with higher accuracy than that of a region of a decoded image having lower reference frequency.

49. A video decoding method for decoding a video bitstream which is coded by a coding system using intra prediction processing and inter-frame prediction processing into an image signal, and performing recompression processing on the decoded image signal by performing quantization in which different numbers of bits are allocated to respective pixels or respective recompression processing units, the method comprising:
determining a reference degree of each pixel or a reference degree of each recompression processing unit according to a pixel position to be referred to in the intra prediction processing in the coding system;
controlling a recompressed data amount such that a number of allocated bits indicating a quantization representative value becomes larger with respect to a pixel having a high reference degree or a recompression processing unit having a high reference degree; and
suppressing accumulation of errors caused in recompression processing.

50. A video decoding method, according to claim 49, further comprising:
determining a reference degree of each pixel or a reference degree of each recompression processing unit according to a pixel position to be referred to in prediction processing in the coding decoding method, and
controlling a recompressed data amount such that a number of allocated bits indicating a quantization representative value becomes larger with respect to a pixel having a high reference degree or a recompression processing unit having a high reference degree.

51. The video decoding method, according to claim 49, wherein the coding system is a coding system using an intra prediction, and
the pixel position to be referred to in generating an prediction image in the coding system is a pixel position to be referred to in generating an intra prediction image.

52. The video decoding method, according to claim 50, wherein the reference degree is determined by using at least one of a coding processing unit of the coding system, a pixel position to be referred to in generating a prediction pixel in the recompression unit, a recompression processing unit of the recompression unit, and a compression rate of the recompression unit.

53. The video decoding method, according to claim 51, comprising, performing quantization with respect to a reference pixel which is one of pixels in the recompression processing unit, and performing quantization with respect to a difference between adjacent pixels for pixels other than the reference pixel.

54. The video decoding method, according to claim 53, wherein a maximum reference degree within the recompression processing unit is determined so as not to be equal to a reference degree of a vertically or laterally adjacent pixel.

55. A program for causing a computer to execute, the computer constituting a video decoding device which performs recompression processing by performing quantization in which different numbers of bits are allocated to respective pixels decoded by an image coding decoding method using prediction processing or respective recompression processing units to thereby acquire recompressed data,
processing to determine a reference degree to each pixel or a reference degree to each recompression processing unit according to a pixel position to be referred to in prediction processing in the coding decoding method, and
controlling a recompressed data amount such that a number of allocated bits indicating a quantization representative value becomes larger with respect to a pixel having a high reference degree or a recompression processing unit having a high reference degree.
